(19) United States
(12) Patent Application Publication
(10) Pub. No.: US 2024/0284333 A1
(43) Pub. Date: Aug. 22, 2024

(54) DEVICE REACHABILITY IN A NON-TERRESTRIAL NETWORK

(71) Applicant: Telefonaktiebolaget LM Ericsson (PUBL), Stockholm (SE)

(72) Inventors: Emre Yavuz, STOCKHOLM (SE); Johan Rune, LIDINGÖ (SE); Xingqin Lin, SAN JOSÈ, CA (US); Olof Liberg, ENSKEDE (SE); Zhipeng Lin, NANJING Jiangsu (CN); Talha Khan, SANTA CLARA, CA (US); Robert Karlsson, SUNDBYBERG (SE)

(21) Appl. No.: 18/681,142

(22) PCT Filed: Aug. 5, 2022
(86) PCT No.: PCT/IB2022/057332

§ 371 Date: Feb. 5, 2024

Related U.S. Application Data
(60) Provisional application No. 63/229,878, filed on Aug. 5, 2021.

(51) Int. Cl. H04W 52/02; H04W 68/02

(52) U.S. Cl. CPC H04W 52/0229; H04W 52/0216; H04W 68/02

(57) ABSTRACT

According to some embodiments, a method performed by a wireless device comprises adapting monitoring of a downlink control channel based on a gap in network coverage overlapping a paging occasion configured for the wireless device. Adapting monitoring of the downlink control channel comprises monitoring the downlink control channel during a replacement paging occasion.

### TECHNICAL FIELD

Embodiments of the present disclosure are directed to wireless communications and, more particularly to improving device reachability in a non-terrestrial network (NTN).

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The Third Generation Partnership Project (3GPP) unites telecommunications standard development organizations and provides an environment to produce the reports and specifications that define 3GPP technologies. In the last couple of years, a topic of discussion within 3GPP relates to how to specify technologies for machine-to-machine (M2M) and/or Internet of things (IoT) use cases. Release 13 specifies enhancements to support machine-type communications (MTC) by introducing new user equipment (UE) categories M1 (Cat-M1) and NB1 (Cat-NB1) to support reduced maximum bandwidth of up to 6 physical resource blocks (PRBs) in an enhanced MTC (eMTC) work item and narrowband carrier in a Narrowband IoT (NB-IoT) work item specifying a new radio interface, respectively.

There are multiple differences between “legacy” long-term evolution (LTE) and the procedures and channels defined for eMTC or NB-IoT. Some important differences include a new physical downlink control channel (PDCCH), i.e., MTC PDCCH (MPDCCH) used in eMTC and Narrowband PDCCH (NPDCCH) used in NB-IoT.

3GPP Release 12 initiated the work on eMTC, also often referred to as LTE-M, and specified the first low-complexity UE category 0 (Cat-0). Cat-0 supports a reduced peak data rate of 1 Mbps, single antenna and half duplex frequency division duplex (HD FDD) operation.

In Release 13, the work accelerated with the introduction of the Cat-M1 UE category. It supports a further reduced complexity, and coverage enhanced (CE) operation. The additional cost reduction came from a reduced transmission and reception bandwidth of 1.08 MHz, equivalent to six 180 KHz PRBs. The introduction of a lower UE power class of 20 dBm, in addition to the 23 dBm power class, further facilitates a lower UE complexity.

Because of the reduction in bandwidth, a new narrowband physical downlink control channel, the MTC physical downlink control channel (MPDCCH), was introduced as a substitute for the wideband legacy physical downlink control channel (PDCCH) and the Enhanced PDCCH (EPDCCH). The Cat-M1 UEs monitor MPDCCH in a narrowband (NB), which is defined by 6 adjacent PRBs.

eMTC supports a maximum coupling loss (MCL) that is 20 dB larger than the normal MCL of LTE. This is achieved mainly through time repetition and a relaxed acquisition time of the physical channels and signals. The primary synchronization signal (PSS) and secondary synchronization signal (SSS) are fully reused from LTE and extended coverage is achieved by increased acquisition time.

For the physical broadcast channel (PBCH), the MPDCCH, the physical uplink control channel (PUCCH) and the data channels, that is, the physical uplink shared channel (PUSCH) and physical downlink shared channel (PDSCH), the desired coverage enhancement is achieved through time repetition of a transmission block.

In LTE Releases 14 and 15, eMTC was further enhanced to support a more diversified set of applications and services. For example, a new UE category (Cat-M2) was specified. The performance of eMTC Release 15 meets the IMT-2020 5G requirements for the massive IoT use case.

The work in 3GPP on eMTC was continued in Release 16 and is further evolved also in Release 17.

A new Release 13 work item referred to as Narrowband IoT (NB-IoT) has the objective of specifying a radio access for cellular IoT that addresses improved indoor coverage, support for massive number of low throughput devices, not sensitive to delay, ultra-low device cost, low device power consumption and (optimized) network architecture.

NB-IoT can be described as a narrowband version of LTE. Similar to eMTC, NB-IoT makes use of increased acquisition times and time repetitions to extend the system coverage. The repetitions can be seen as a third level of retransmissions added at the physical layer as a complement to those at medium access control (MAC) hybrid automatic repeat request (HARQ) and radio link control (RLC) automatic repeat request (ARQ). A NB-IoT downlink carrier is defined by 12 orthogonal frequency-division multiplexing (OFDM) sub-carriers, each of 15 kHz, giving a total baseband bandwidth of 180 kHz. When multiple carriers are configured, several 180 kHz carriers can be used, e.g., for increasing the system capacity, inter-cell interference coordination, load balancing, etc. This design gives NB-IoT a high deployment flexibility.

NB-IoT supports 3 different deployment scenarios or mode of operations:

‘Stand-alone operation’ utilizing for example the spectrum currently being used by global system for mobile communications (GSM) EDGE radio access network (GERAN) systems as a replacement of one or more GSM carriers. In principle it operates on any carrier frequency which is neither within the carrier of another system nor within the guard band of another system's operating carrier. The other system can be another NB-IoT operation or any other radio access technology (RAT), e.g., LTE.

‘Guard band operation’ utilizing the unused resource blocks within an LTE carrier's guard-band. The term guard band may also interchangeably be referred to as guard bandwidth. As an example, for LTE bandwidth of 20 MHZ (i.e., Bw1=20 MHz or 100 RBs), the guard band operation of NB-IoT may be anywhere outside the central 18 MHz but within 20 MHz LTE bandwidth.

‘In-band operation’ utilizing resource blocks within a normal LTE carrier. The in-band operation may also interchangeably be referred to as in-bandwidth operation. More generally, the operation of one RAT within the bandwidth of another RAT is also referred to as in-band operation. As an example, in a LTE bandwidth of 50 RBs (i.e., Bw1=10 MHz or 50 RBs), NB-IoT operation over one resource block (RB) within the 50 RBs is referred to as in-band operation.

NB-IoT also defines anchor and non-anchor carriers. In an anchor carrier, the UE assumes that anchor-specific signals (including NPSS, NSSS, NPBCH, and SIB-NB) are transmitted on downlink. In a non-anchor carrier, the UE does not assume that NPSS, NSSS, NPBCH, and SIB-NB are transmitted on downlink. The anchor carrier is transmitted on at least subframes #0, #4, #5 in every frame and subframe #9 in every other frame. Additional downlink subframes in a frame may also be configured on an anchor carrier by means of a downlink bit map.

The anchor carriers transmitting NPBCH or SIB-NB also contain a narrowband reference signal (NRS). The non-anchor carrier contains NRS during certain occasions, and UE-specific signals (such as NPDCCH, NPDSCH, NRS, NPDCCH, and NPDSCH) are also transmitted on an anchor carrier.

The resources for non-anchor carrier are configured by the network node. The non-anchor carrier can be transmitted in any subframe as indicated by a downlink bit map. For example, an eNB signals a downlink bit map of downlink subframes using radio resource control (RRC) message (DL-Bitmap-NB) which are configured as non-anchor carrier. The anchor carrier and/or non-anchor carrier may typically be operated by the same network node e.g., by the serving cell. But the anchor carrier and/or non-anchor carrier may also be operated by different network nodes.

A discontinuous reception (DRX) mechanism facilitates the UE to not be awake all the time when in idle or connected mode to decode the data, e.g., paging message, system information update notification or user data that can be transmitted in the downlink. Using DRX, the UE does not need to monitor for PDCCH transmission in every subframe to check if there is downlink data available. The main motivation is to avoid UE power consumption and thus extend UE battery lifetime.

The eNB configures DRX with a set of DRX parameters that are configured based on the characteristics of the traffic. When DRX is enabled, there is a delay when receiving data in the downlink when the UE is not active and thus proper configuration the DRX parameters is important to minimize packet delay and maximizes power savings.

During DRX mode, a UE listens to the downlink when the UE is in active state, whereas in sleep state the UE does not monitor for receiving PDCCH transmissions, if any exist, from the eNB.

3GPP Release 15 specifies the first release of the 5th generation (5G) system (5GS). This new generation radio access technology intends to serve use cases such as enhanced mobile broadband (eMBB), ultra-reliable and low latency communication (URLLC), and mMTC. The 5G specification includes the New Radio (NR) access stratum interface and the 5G Core Network (5GC). The NR physical and higher layers reuse parts of the LTE specification and add components as needed for the new use cases.

In Release 15, 3GPP started work to prepare NR for operation in a non-terrestrial network (NTN). The work was performed within the study item “NR to support Non-Terrestrial Networks” and resulted in 3GPP Technical Report (TR) 38.81. In Release 16, the work to prepare NR for operation in an NTN network continues with the study item “Solutions for NR to support Non-Terrestrial Network.” In parallel, the interest to adapt LTE for operation in NTN is growing. As a consequence, 3GPP is considering introducing support for NTN in both LTE and NR in Release 17.

A satellite radio access network usually includes the following components: a satellite, which is a space-borne platform; an Earth-based gateway connects the satellite to a base station or a core network, depending on the choice of architecture; a feeder link is the link between a gateway and a satellite; and an access link is the link between a satellite and a UE.

Depending on the orbit altitude, a satellite may be categorized as low earth orbit (LEO), medium earth orbit (MEO), or geostationary earth orbit (GEO) satellite. A LEO includes typical heights ranging from 250-1,500 km, with orbital periods ranging from 90-120 minutes. A MEO includes typical heights ranging from 5,000-25,000 km, with orbital periods ranging from 3-15 hours. A GEO includes height at about 35,786 km, with an orbital period of 24 hours.

Satellite systems tend to have significantly higher path loss than terrestrial networks due to their significant orbit height. Overcoming the path loss often requires the access and feeder links to operate in line-of-sight conditions and the UE to be equipped with an antenna offering high beam directivity.

A communication satellite typically generates several beams over a given area. The “footprint” or “spotbeam” of a beam is usually in an elliptic shape, which has been traditionally referred to as a cell. The spotbeam may move over the earth surface with the satellite movement (often referred to as the moving beam or moving cell case). Or the spotbeam may be earth-fixed where the satellite uses a beam pointing mechanism to compensate for its motion (often referred to as the earth-fixed beam or earth-fixed cell case). The size of a spotbeam depends on the system design and may range from tens of kilometers to a few thousands of kilometers.

FIG. 1 illustrates an example architecture of a satellite network with bent pipe transponders. The illustrated example includes a terrestrial gateway in communication with the satellite via a feeder link. Also illustrated are four spotbeams. The satellite is in communication with the wireless device via the access link.

In comparison to the beams observed in a terrestrial network, the NTN beam may be wide and may cover an area outside of the area defined by the served cell. A beam covering adjacent cells will overlap and cause significant levels of intercell interference. A typical approach for overcoming the large levels of interference in the NTN involves configuring different cells with different carrier frequencies and polarization modes.

In a LEO NTN, the satellites are moving with a very high velocity. This leads to a Doppler shift of the carrier frequency on the service link of up to 24 ppm for a LEO satellite at 600 km altitude. The Doppler shift is also time variant due to the satellite motion over the sky. The Doppler shift may vary with up to 0.27 ppm/s for a LEO 600 km satellite. The Doppler shift will impact, i.e., increase or decrease, the frequency received on the service link compared to the transmitted frequency.

For GEO NTN, the satellites may move in an orbit inclined relative to the plane of the equator. The inclination introduces a periodic movement of the satellite relative to earth which introduces a predictable, and daily periodically repeating Doppler shift of the carrier frequency as exemplified in FIG. 2.

FIG. 2 is graph illustrating an example of the diurnal Doppler shift of the forward service link observed for a GEO satellite operating from an inclined orbit. The horizontal axis represents time and the vertical axis represents the Doppler shift.

TR 38.821 describes scenarios where ephemeris data should be provided to the UE, for example, to assist with pointing a directional antenna (or an antenna beam) towards the satellite. A UE that knows its own position, e.g., based on Global Navigation Satellite System (GNSS) support, may also use the ephemeris data to calculate correct timing advance (TA) and Doppler shift.

A satellite orbit can be fully described using six parameters. A user can choose which set of parameters to use and many different representations are possible. For example, the set of parameters (a, ε, i, Ω, ω, t) is often used in astronomy. Here, the semi-major axis “a” and the eccentricity “ε” describe the shape and size of the orbit ellipse; the inclination “i,” the right ascension of the ascending node “Ω,” and the argument of periapsis “ω” determine its position in space, and the epoch “t” determines a reference time (e.g., the time when the satellites moves through periapsis). This set of parameters is illustrated in FIG. 3.

FIG. 3 illustrates orbital elements. In FIG. 3, the periapsis refers to a point where the orbit is nearest to Earth, the first point of Aries refers to the direction towards the sun at the March equinox, and the ascending node refers to the point where the orbit passes upwards through the equatorial plane.

A two-line element set (TLE) is a data format encoding a list of orbital elements of an Earth-orbiting object for a given point in time, the epoch. As an example of a different parametrization, the TLEs may use mean motion “n” and mean anomaly “M” instead of a and t.

A different set of parameters is the position and velocity vector (x, y, z, vₓ, v_{y}, v_{z}) of a satellite. These are sometimes referred to as orbital state vectors. They can be derived from the orbital elements and vice versa, because the information they contain is equivalent. All these formulations (and many others) are possible choices for ephemeris data format for use in NTN.

It is important that a UE can determine the position of a satellite with accuracy of at least a few meter. However, several studies have shown that this might be hard to achieve when using the de-facto standard of TLEs. On the other hand, LEO satellites often have GNSS receivers and can determine their position with meter level accuracy.

Another aspect discussed during the study item and captured in 3GPP TR 38.821 is the validity time of ephemeris data. Predictions of satellite positions in general degrade with increasing age of the ephemeris data used, due to atmospheric drag, maneuvering of the satellite, imperfections in the orbital models used, etc. Therefore, the publicly available TLE data are updated quite frequently, for example.

The update frequency depends on the satellite and its orbit. For example, the update frequency may range from multiple times a day (e.g., for satellites on very low orbits which are exposed to strong atmospheric drag and need to perform correctional maneuvers often) to weekly (e.g., for satellites on relatively higher orbits or satellites that are exposed to less atmospheric drag).

While it seems possible to provide the satellite position with the required accuracy, care should be taken to meet these requirements, e.g., when choosing the ephemeris data format or when choosing the orbital model to be used for the orbital propagation.

Ephemeris data consists of at least 5 parameters describing the shape and position in space of the satellite orbit. It also includes a timestamp, which is the time when the other parameters describing the orbit ellipse were obtained. The position of the satellite at any given time in the near future may be predicted from this data using orbital mechanics. The accuracy of the prediction will, however, degrade as for projections further and further into the future. The validity time of a certain set of parameters depends on many factors like the type and altitude of the orbit, but also the desired accuracy, and ranges from the scale of a few days to a few years.

There currently exist certain challenges. For example, the main challenges when evolving cellular technologies such as NR, LTE, eMTC and NB-IoT to support NTN are moving satellites (resulting in moving cells or switching cells), long propagation delays, and large Doppler shifts.

For moving satellites (resulting in moving or switching cells), a problem is that the default assumption in terrestrial network design, e.g., NR or LTE, is that cells are stationary. This is not the case in NTN, especially for LEO satellites. A LEO satellite may be visible to a UE on the ground only for a few seconds or minutes.

There are two different options for LEO deployment. In one option, the beam/cell coverage is fixed with respect to a geographical location with earth-fixed beams, i.e., steerable beams from satellites ensure that a certain beam covers the same geographical area even as the satellite moves in relation to the surface of the earth. In another option, with moving beams a LEO satellite has fixed antenna pointing direction in relation to the earth's surface, e.g., perpendicular to the earth's surface, and thus cell/beam coverage sweeps the earth as the satellite moves. In that case, the spotbeam, which is serving the UE, may switch every few seconds.

Regarding long propagation delays, the propagation delays in terrestrial mobile systems are usually less than 1 millisecond. In contrast, the propagation delays in NTN can be much longer, ranging from several milliseconds (LEO) to hundreds of milliseconds (GEO) depending on the altitudes of the spaceborne or airborne platforms deployed in the NTN.

Regarding large Doppler shifts, the movements of the spaceborne or airborne platforms deployed in NTN may result in large Doppler shifts. For example, a LEO satellite at the height of 600 km can lead to a time-varying Doppler shift as large as 24 ppm.

In both earth-fixed and earth moving cells, a UE may experience cells moving towards and away from itself assuming that it is stationary (or can be considered as stationary) with respect to the satellites. Depending on the deployment, there may also be occasional coverage gaps due to missing a satellite or satellites that would have provided the coverage as part of the constellation.

Typically, a device camping on a network expects continuous network availability. This is in contrast to camping on a network where the radio access network associated with satellites, e.g., LEO, MEO or GEO, is moving and not providing continuous coverage. In this case, the radio access network associated with satellites can be available occasionally, e.g., periodically or aperiodically. Such coverage gaps result a UE not being reachable by the network when the gap coincides with the UE paging occasions. It may also result in a UE wasting power performing RRC_IDLE state and RRC_INACTIVE state procedures, such as cell searches and ‘NAS-attach’ procedures, when there is no coverage.

During discontinuous reception, a UE can switch off the receiver for a configured period of time, i.e., a sleep cycle, to reduce battery energy consumption. A DRX cycle consists of alternating on and off periods with configured duty cycles and it indicates the number of subframes that the UE may sleep. In idle mode, DRX cycles are also referred to as paging cycles and the following values have been specified: 0.32, 0.64, 1.28, and 2.56 seconds. Extended DRX cycles were introduced in Release 13 so that the UE may sleep longer (up to ˜44 minutes for LTE-M and 3 hours for NB-IoT) and thus be able to extend the battery life provided that there is no need for the network to reach the UE frequently. It is up to the UE when to trigger access for transmission in the uplink.

A paging occasion may coincide with a time when there is no network coverage, i.e., no satellite serving the area at that time. This means that the network has to wait at least until the next paging occasion to reach the UE if there is network coverage by then. The impact of discontinuous coverage on reachability may be limited when DRX cycles, i.e., cycles up to 2.56 secs, are considered, but for extended DRX cycles or power saving mode (PSM), especially the ones with large values, the impact may not be negligible because a missed occasion results in a long wait before having another chance to page the UE.

### SUMMARY

As described above, certain challenges currently exist with device reachability in a non-terrestrial network (NTN). Certain aspects of the present disclosure and their embodiments may provide solutions to these or other challenges. Particular embodiments minimize the impact of discontinuous NTN coverage on user equipment (UE) reachability.

Particular embodiments enable the wireless device to adapt monitoring of downlink control channels, e.g., adjustments to the discontinuous reception (DRX) or power saving mode (PSM) cycles, with respect to the availability of network coverage when coverage gaps coincide with paging occasions leading to the network not being able to reach the UE within an expected time, for example, with respect to configured (e)DRX or PSM cycle. Particular embodiments enable a wireless device to adapt monitoring of downlink control channels with respect to the availability of network coverage when coverage gaps coincide with paging occasions that lead to the network not being able to reach the wireless device within an expected time.

According to some embodiments, a method performed by a wireless device comprises adapting monitoring of a downlink control channel based on a gap in network coverage overlapping a paging occasion configured for the wireless device. Adapting monitoring of the downlink control channel comprises monitoring the downlink control channel during a replacement paging occasion.

In particular embodiments, the method comprises monitoring the downlink control channel both during the paging occasion configured for the wireless device and during the replacement paging occasion.

In particular embodiments, based on the gap in the network coverage overlapping the paging occasion configured for the wireless device, the method further comprises abstaining from monitoring the paging occasion configured for the wireless device.

In particular embodiments, the replacement paging occasion includes a paging occasion prior to the gap in network coverage and/or after the gap in network coverage. The paging occasion configured for the wireless device may be based on an active portion of a discontinuous reception cycle or a power saving mode cycle. The replacement paging occasion occurs outside of the active portion of the discontinuous reception cycle or the power saving mode cycle.

In particular embodiments, the method further comprises determining that the gap in network coverage overlaps the paging occasion configured for the wireless device and sending, to a network node, information indicating that the gap in network coverage overlaps the paging occasion configured for the wireless device.

In particular embodiments, the method further comprises determining (1116) a configuration of the replacement paging occasion. The configuration of the replacement paging occasion may indicate when the replacement paging occasion occurs. The configuration of the replacement paging occasion may be determined at least in part based on information received from a network node.

According to some embodiments, a wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method performed by a network node comprises adapting when to page a wireless device via a downlink control channel based on a gap in network coverage of the wireless device overlapping a paging occasion configured for the wireless device. Adapting when to page the wireless device comprises paging the wireless device during a replacement paging occasion.

In particular embodiments, the method comprises paging the wireless device both during the paging occasion configured for the wireless device and during the replacement paging occasion.

In particular embodiments, based on the gap in the network coverage overlapping the paging occasion configured for the wireless device, the network node abstains from paging the wireless device during the paging occasion configured for the wireless device.

In particular embodiments, the replacement paging occasion includes a paging occasion prior to the gap in network coverage or after the gap in network coverage. The paging occasion configured for the wireless device may be based on an active portion of a discontinuous reception cycle or a power saving mode cycle. The replacement paging occasion occurs outside of the active portion of the discontinuous reception cycle or the power saving mode cycle.

In particular embodiments, the method further comprises receiving, from the wireless device, information indicating that the gap in network coverage overlaps the paging occasion configured for the wireless device. Adapting when to page the wireless device is based at least in part on receiving the information.

In particular embodiments, the method further comprises determining information to enable the wireless device to determine a configuration of the replacement paging occasion. The configuration of the replacement paging occasion may indicate when the replacement paging occasion occurs. The method may further comprise sending, to the wireless device, the information that enables the wireless device to determine the configuration of the replacement paging occasion.

According to some embodiments, a network node comprises processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments improve reachability of a wireless device. Particular embodiments enable data to reach the wireless device within an expected time, for example, with respect to configured (e)DRX or PSM cycle when coverage gaps coincide with paging occasions.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example architecture of a satellite network with bent pipe transponders;

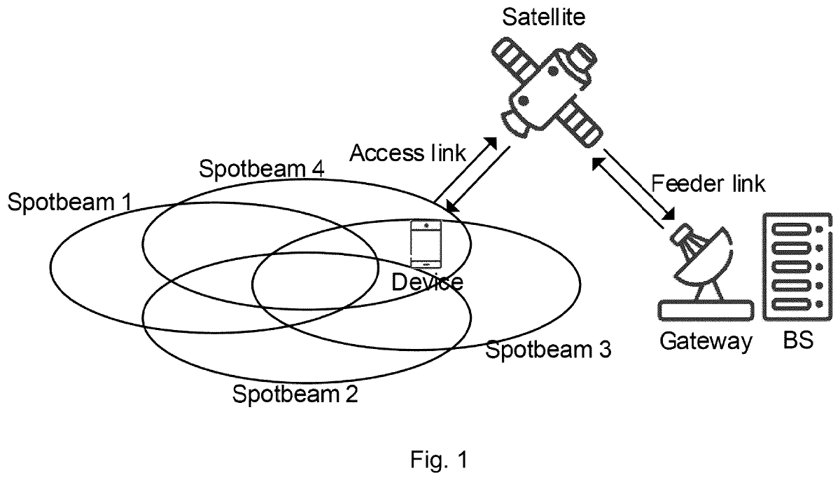

FIG. 2 is graph illustrating an example of the diurnal Doppler shift of the forward service link observed for a GEO satellite operating from an inclined orbit;

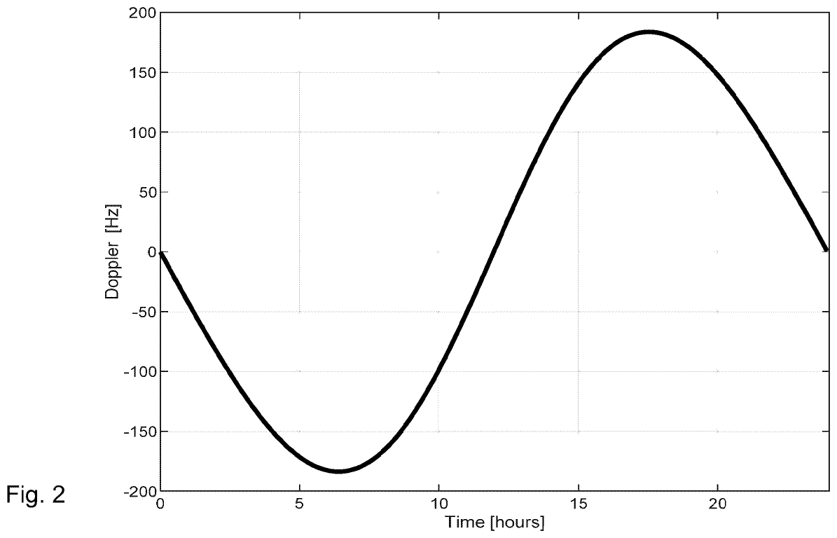

FIG. 3 illustrates orbital elements;

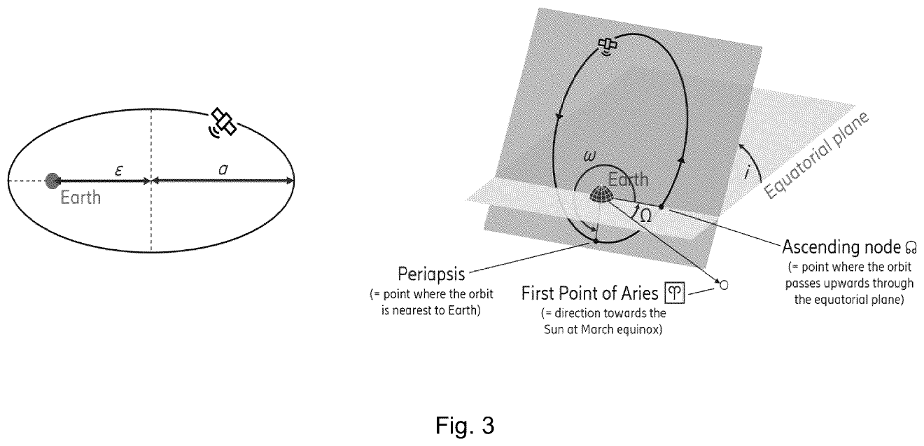

FIG. 4 illustrates a first example of time windows on either side of a coverage gap;

FIG. 5 illustrates a second example of time windows on either side of a coverage gap;

FIG. 6 illustrates a third example of time windows on either side of a coverage gap;

FIG. 7 illustrates example configuration of multiple DRX cycles in the vicinity of a coverage gap;

FIG. 8 illustrates an example configuration of different sleep cycles in the vicinity of a coverage gap;

FIG. 9 is a block diagram illustrating an example wireless network;

FIG. 10 illustrates an example user equipment, according to certain embodiments;

FIG. 11 is flowchart illustrating an example method in a wireless device, according to certain embodiments;

FIG. 12 is flowchart illustrating an example method in a network node, according to certain embodiments;

FIG. 13 illustrates a schematic block diagram of a network node and a wireless device in a wireless network, according to certain embodiments;

FIG. 14 illustrates an example virtualization environment, according to certain embodiments;

FIG. 15 illustrates an example telecommunication network connected via an intermediate network to a host computer, according to certain embodiments; and

FIG. 16 illustrates an example host computer communicating via a base station with a user equipment over a partially wireless connection, according to certain embodiments.

### DETAILED DESCRIPTION

As described above, certain challenges currently exist with device reachability in a non-terrestrial network (NTN). Certain aspects of the present disclosure and their embodiments may provide solutions to these or other challenges. Particular embodiments minimize the impact of discontinuous NTN coverage on user equipment (UE) reachability. Particular embodiments enable a wireless device to adapt monitoring of downlink control channels with respect to the availability of network coverage when coverage gaps coincide with paging occasions.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Although certain embodiments outlined below are described in terms of long term evolution (LTE) based (including Internet of things (IoT)) NTNs, the embodiments are equally applicable in a NTN based on new radio (NR) (including IoT) technology.

Although certain embodiments use the term “network” to refer to or include a network node, which typically comprises an eNB (e.g., in an LTE-based NTN), it may also be a gNB (e.g., in an NR-based NTN), or a base station or an access point in another type of network, or any other network node with the ability to communicate directly or indirectly with a UE.

Global Navigation Satellite Systems (GNSS) play a role in certain embodiments. The most well-known is the American Global Positioning System (GPS), but there are also other similar systems that may provide the functionality for particular embodiments, e.g., the Russian Global Navigation Satellite System (GLONASS), the Chinese BeiDou Navigation Satellite System and the European Galileo.

The terms “idle mode” and “RRC_IDLE state” are used interchangeably in this document.

For convenience, the term “satellite” is often used even when a more appropriate term may be “gNB associated with the satellite.” Here, gNB associated with a satellite might include both a regenerative satellite, where the gNB is the satellite payload, i.e., the gNB is integrated with the satellite, or a transparent satellite, where the satellite payload is a relay and the gNB is on the ground (i.e., the satellite relays the communication between the gNB on the ground and the UE).

The term signal or radio signal used herein can be any physical signal or physical channel. Examples of downlink physical signals are reference signal (RS) such as NPSS, NSSS, NRS, CSI-RS, DMRS, signals in SSB, DRS, CRS, PRS, etc. Examples of uplink physical signals are reference signal such as SRS, DMRS etc. The term physical channel refers to any channel carrying higher layer information e.g., data, control, etc. Examples of physical channels are PBCH, NPBCH, PDCCH, PDSCH, MPDCCH, NPDCCH, NPDSCH, E-PDCCH, PUSCH, PUCCH, NPUSCH, etc.

The term “wireless device” may refer to a UE or other wireless device.

In particular embodiments, to save battery energy (and thus battery lifetime), a UE adapts monitoring of downlink control channels, for example for paging, with respect to the availability of coverage so that during times of network unavailability, the UE is permitted to suspend RRC IDLE and RRC INACTIVE procedures. Such adaptation is facilitated if the UE is informed about when the UE can expect the network to be available.

Leveraging the predictability of coverage gaps, certain embodiments rely on assigning/selecting one or more additional, or special, paging occasion(s) (PO(s)) to a UE for which one or more regular PO(s) occur(s) during a coverage gap (or, as one option, occur(s) prior to a coverage gap without leaving enough time for the UE to respond to a page before the coverage gap). Such additional, or special, POs are herein also referred to as “replacement POs.”

Some embodiments select paging occasions to monitor prior to or after coverage gap(s). In some embodiments, the UE calculates the paging occasions that coincide with potential coverage gap(s), for example, based on what the UE estimates using satellite assistance information, e.g., satellite ephemeris information, or any other information such as broadcast information that indicates an area where there is no network coverage. The UE selects a particular paging occasion or a set of paging occasions that do not coincide with UE active times due to discontinuous reception, i.e., DRX, eDRX or PSM configuration. Note that in TS36.321, “active time” is defined as the time related to DRX operation, as defined in clause 5.7, during which the medium access control (MAC) entity monitors the physical downlink control channel (PDCCH).

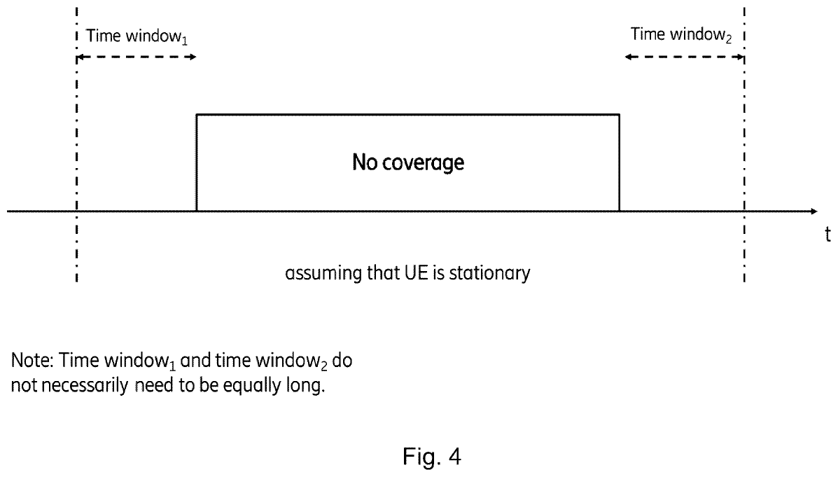

The UE may inform the network before the coverage gap that the UE would be monitoring those occasions for paging. Those paging occasion(s) may be indicated via absolute time or using a reference point such as the n-th subframe of an m-th radio frame of a k-th hyper frame so that the UE and the network are in synchronization. The UE may select any subframe or one of the valid subframes for paging (e.g., subframes constituting POs according to the cell's configuration, either according to the regular PO algorithm or according to additional configuration of special POs) from a set of subframes within a certain time window indicated by the network with an offset prior to, i.e., time window₁ in FIG. 4, or after the coverage gap, i.e., time window₂ in FIG. 4, so that the impact on reachability may be reduced while the change on UE energy consumption is limited.

FIG. 4 illustrates a first example of time windows on either side of a coverage gap. The horizontal axis represents time.

In some embodiments, the UE may inform the network before the coverage gap that the UE would be monitoring occasions for paging during the gap via one or more of the following ways. For example, when the UE is in RRC connected state and the gNB indicates additional paging occasions to the UE (via broadcasting or dedicated signaling or static configured in the specification), the UE may indicate to the gNB that the UE can monitor all additional paging occasions while the UE is in coverage. The UE may also inform the gNB of when it will be in coverage depending on if the gNB has that information or not.

When UE is in RRC connected state, and if the uplink timing alignment timer is running, the UE can indicate/request the monitoring of a set of additional POs via normal physical uplink shared channel (PUSCH) transmission addressed by cell radio network temporary identifier (C-RNTI). As an example, the monitoring of a set of additional POs can start after a time duration after the slot where the additional PO monitoring indication is received, wherein the set of additional POs and/or the time duration may be either predetermined or configured by the network.

When UE is in RRC idle/inactive sate, the UE can indicate/request that a set of additional POs will be monitored via a physical random access channel (PRACH) transmission. As an example, a specific PRACH preamble may be reserved for requesting monitoring of a set of additional POs after the PRACH occasion, wherein a time duration between the end of the PRACH occasion for requesting/indicating PO monitoring and the start of the first additional PO to be monitored may be either predetermined or configured by the network. This is similar to a system information (SI) request, but it is for requesting to monitor the paging transmission on additional occasions, while SI request is to request the network to broadcast the system information.

In some embodiments, the UE calculates the paging occasions that coincide with potential coverage gap(s) or fall within a certain time window indicated by the network with an offset prior to the coverage gap(s) and chooses not to monitor these paging occasions. In one non-limiting example, the UE informs the network before the coverage gap that the UE will not be monitoring those occasions for paging. The UE may in addition choose to proactively poll the network for downlink data before going out of network coverage. This enables the network to empty its downlink data buffer associated with the UE before the UE becomes unreachable.

In some embodiments, the UE informs the network before the coverage gap that that the UE would be monitoring occasions for paging during the gap via one or more of the following ways. For example, when UE is in RRC connected state, and if the uplink timing alignment timer is running, the UE may indicate/request the skipping of a number of POs via normal PUSCH transmission addressed by C-RNTI. As an example, the number of skipped POs can start after a time duration after the slot the PO skipping indication is received, wherein the number of POs and/or the time duration may be either predetermined or configured by the network.

When UE is in RRC idle/inactive sate, the UE may indicate/request that a set of POs will be skipped via a PRACH transmission. As an example, a specific PRACH preamble may be reserved for requesting cancellation of a set of POs after the PRACH occasion, wherein the time duration between the end of the PRACH occasion for PO cancellation request and the start of the PO may be either predetermined or configured by network. This is similar to a SI request, but it is for requesting to cancel the paging transmission on some occasions while SI request is to request network to broadcast the system information.

In another non-limiting example, the network configures the functionality that enables the UE to skip monitoring of the paging occasions coinciding with potential coverage gap(s) or falling within a certain time window prior to the coverage gap(s), in which case the UE does not need to inform the network that it would not be monitoring those occasions for paging.

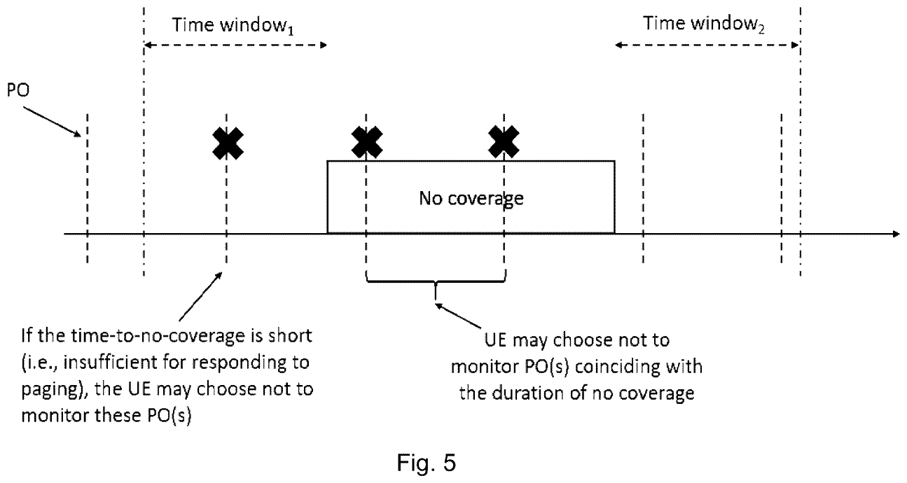

FIG. 5 illustrates a second example of time windows on either side of a coverage gap, where a UE may choose not to monitor paging occasions that coincide with the coverage gap or fall within a certain time window prior to the coverage gap.

In some embodiments, such offsets (marking the time windows) may be indicated to the UE via broadcast information or dedicated signaling, e.g., when the UE registers with the network and/or when the UE updates or periodically informs its location to the network.

In LTE, the non-access stratum (NAS) messages involved in these procedures are Attach Request message from the UE (for initial registration), where the network may include the offset/window information in the Attach Accept message, the Tracking Area Update Request message (with the evolved packet system (EPS) registration type information element (IE) set to respectively “TA updating” or “periodic updating”), where the network may include the offset/window information in the Tracking Area Update Accept message.

In NR, the NAS message sent from the UE is the same in all these procedures, i.e., Registration Request (with the 5GS registration type IE set to respectively “initial registration”, “mobility registration updating” or “periodic registration updating”), where the network may include the offset/window information in the Registration Accept message.

In some embodiments, the network assigns certain rules such how to select the subframe to monitor for paging based on the value of the UE's configured (e)DRX or PSM cycle. In some embodiments, the UE may randomly select from a set of POs configured individually for a particular UE or a group of UEs (or all UEs) or select based on an identifier such as UE-ID (e.g., the UE_ID parameter or the UE_ID_H parameter used in the currently specified PO algorithms (further described below). The set of POs to select from can be associated with multiple time windows from which the UE selects based on an identifier such as UE-ID (e.g., the UE_ID parameter or the UE_ID_H parameter used in the currently specified PO algorithms (further described below) and/or the UE's configured (e)DRX or PSM cycle to randomize so that the same PO, e.g., that closer to the coverage gap, is not selected. In some embodiments, the network indicates the exact PO(s) a specific UE should use, e.g., using dedicated signaling, such as an RRCConnectionRelease message in LTE or an RRCRelease message in NR, and then the UE reporting of its selected PO(s) may be omitted.

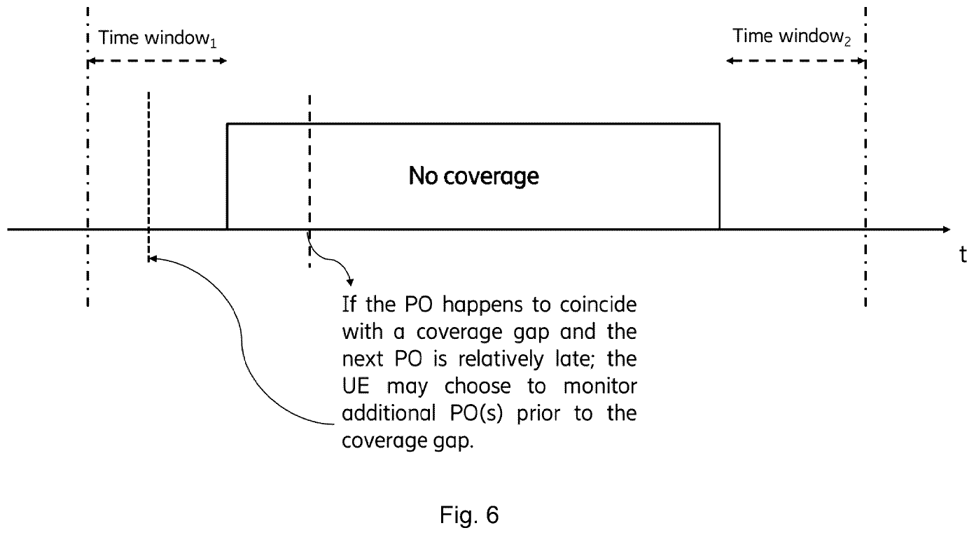

In some embodiments, the UE may inform the network by providing the selected paging occasion(s) using the existing paging information container, e.g., with a new IE parameter. An alternative is to use a new container, a new message or a new IE parameter in an existing message, e.g., “UE assistance information” to convey such information. Some embodiments may convey the information on NAS level or use any combination of the options above. In some embodiments, the network may indicate, via broadcast or dedicated signaling, if the UE is allowed to select such POs prior to and/or after the coverage gap based on the length of the (c)DRX or PSM cycle, e.g., possible to select if the configured eDRX cycle is larger than a particular value. An example is illustrated in FIG. 6.

FIG. 6 illustrates an example of time windows on either side of a coverage gap. In the illustrated example, a UE monitors additional POs prior to the coverage gap.

In some embodiments, the network provides the PO(s) at which it can potentially page a UE prior to and/or after the coverage gap. Similar to the embodiment above, the paging occasion(s) may be indicated via absolute time or using a reference point such as the n-th subframe of an m-th radio frame of an k-th hyper frame so that the UE and the network are synchronized. The UE can select the PO(s) based on an identifier such as UE-ID (e.g., the UE_ID parameter or the UE_ID_H parameter used in the currently specified PO algorithms (further described below) from a set of subframes valid for paging within a certain time window indicated by the network with an offset prior to, i.e., time window₁ or after the coverage gap, i.e., time window₂ so that the impact on reachability may be reduced while the change on UE energy consumption is limited. In a variant, the network indicates the exact PO(s) a specific UE should use, e.g., using dedicated signaling, such as an RRCConnectionRelease message in LTE or an RRCRelease message in NR, and then the UE reporting of its selected PO(s) may be omitted.

In some embodiments, such offsets (time windows) may be indicated to the UE via broadcast information or dedicated signaling, e.g., when the UE registers with the network (first time or during a periodic update/registration, involving the same messages as previously described). The network may assign certain rules such as how to select the subframe to monitor for paging based on the value of the UE's configured (e)DRX or PSM cycle. In another variant, the UE may select based on a formula from a set of POs configured individually for a particular UE or a group of UEs (or all UEs) based on an identifier such as UE-ID (e.g., the UE_ID parameter or the UE_ID_H parameter used in the currently specified PO algorithms (further described below). The set of POs to select from can be associated with multiple time windows from which the UE selects based on an identifier such as UE-ID (e.g., the UE_ID parameter or the UE_ID_H parameter used in the currently specified PO algorithms (further described below) and/or the UE's configured (e)DRX or PSM cycle.

The transition from out-of-coverage to in-coverage may not be as deterministic and predictable as illustrated in, e.g., FIG. 4. In some embodiments, a UE is configured to alert the network that it has again entered coverage. After the UE has accessed the network to indicate its in-coverage presence, the network may, e.g., resume paging to the UE.

In the embodiments described above, in the POs overlapping with or close to the non-coverage-window, the UE may still monitor the DCI with CRC scrambled by P-RNTI, and only skip the decoding of the scheduled PDSCH with paging message.

As an example, when the field Short Message indicator (defined in the Table 7.3.1.2.1-1 of 38.212 V16.6.0 copied below) in DCI received has a value ‘01’, ‘11’, the paging messages may be discarded.

Table 7.3.1.2.1-1 of 38.212 V16.6.0: Short Message indicator

| Bit | |
|---|---|
| field | Short Message indicator |
| 00 | Reserved |
| 01 | Only scheduling information for Paging is present in the DCI |
| 10 | Only short message is present in the DCI |
| 11 | Both scheduling information for Paging and short message are |
| | present in the DCI |

In some embodiments, in the POs overlapping with or close to the non-coverage-window, whether to skip the paging PDSCH is indicated by the DCI with CRC scrambled by P-RNTI.

With this method, when a UE indicates to the network that the UE may want to skip some POs in a time duration without coverage, the network may respond to UEs that such skipping is allowed.

As an example, a new type of short message skipPagingMonitoring may be defined to indicate that skipping paging monitoring in the paging occasion without coverage in NTN.

Updated Table 6.5-1 of 38.331 V16.5.0: Short Messages

| Bit | Short Message |
|---|---|
| 1 | systemInfoModification |
| | If set to 1: indication of a BCCH modification other than SIB6, |
| | SIB7 and SIB8. |
| 2 | etwsAndCmasIndication |
| | If set to 1: indication of an ETWS primary notification and/or |
| | an ETWS secondary notification and/or a CMAS notification. |
| 3 | stopPagingMonitoring |
| | This bit can be used for only operation with shared spectrum |
| | channel access and if nrofPDCCH-MonitoringOccasionPerSSB-InPO |
| | is present. |
| | If set to 1: indication that the UE may stop monitoring PDCCH |
| | occasion(s) for paging in this Paging Occasion as specified in |
| | TS 38.304 [20], clause 7.1. |
| 4 | skipPagingMonitoring |
| | If set to 1: Skip the paging monitoring in the paging occasion |
| | without coverage in NTN |
| 5-8 | Not used in this release of the specification and shall be |
| | ignored by UE if received. |

In another example, some reserved bits may be used in the DCI with CRC scrambled by P-RNTI to indicate that paging is skipped in paging occasion without coverage.

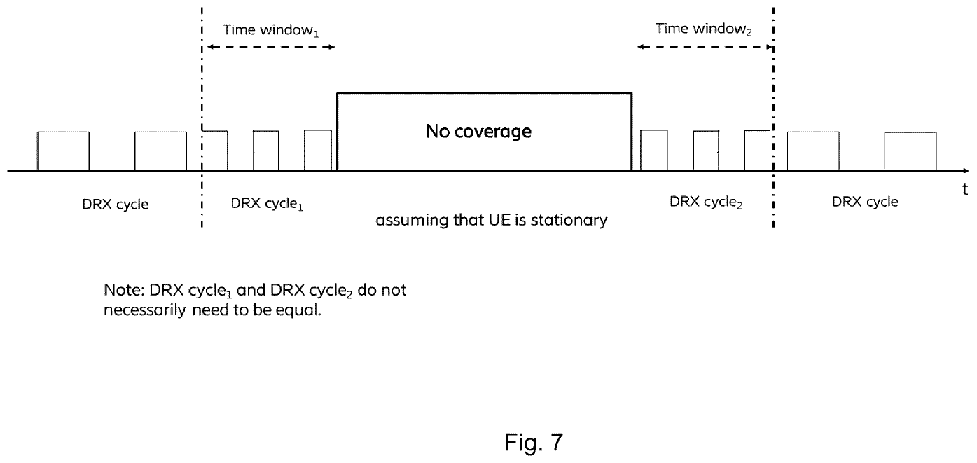

Some embodiments include configuring multiple DRX cycles in the vicinity of coverage gap(s). Similar to the embodiments above, the network may indicate time windows with an offset prior to, i.e., time window₁ in FIG. 7, or after the coverage gap, i.e., time window₂ in FIG. 7, and the UE is configured with a different (e)DRX or PSM cycle within the time window(s). In a variant, the network may indicate, via broadcast or dedicated signaling, if the UE is allowed to select such sleeping cycles (within time windows) prior to and/or after the coverage gap based on the length of the (e)DRX or PSM cycle (here the text refers to the legacy DRX cycles not the ones introduced herein), e.g., possible to select if the configured eDRX cycle is larger than a particular value.

FIG. 7 illustrates example configuration of multiple DRX cycles in the vicinity of a coverage gap. Note that only DRX cycles are shown as an example in FIG. 7, but those may be an eDRX or a PSM cycle.

Note that in the text below, the term “DRX cycle” is used interchangeably with DRX, eDRX, PSM cycles or similar.

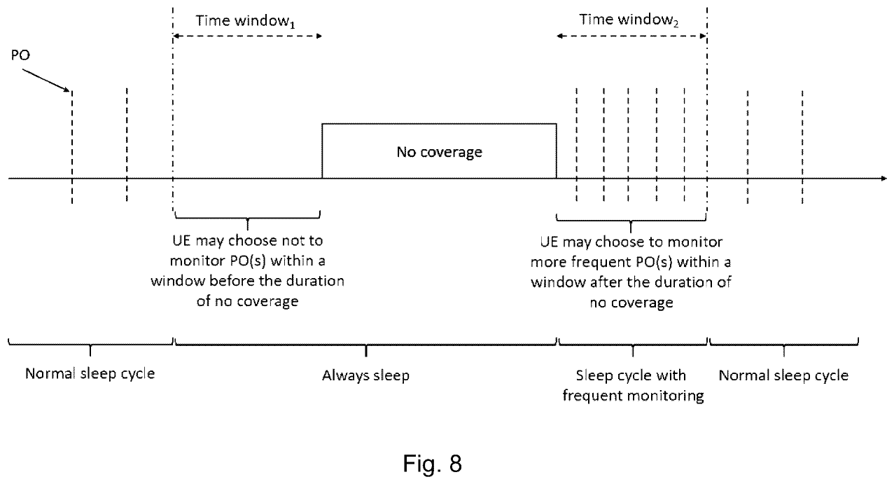

In some embodiments, the network indicates time windows with an offset prior to, i.e., time window₁ or after the coverage gap, i.e., time window₂. In time window₁, the UE is allowed to skip the monitoring occasions and may enter sleep. In time window₂, the UE is configured with a (e)DRX or PSM cycle that has frequent monitoring occasions (more frequent than in the normal case where there is coverage and outside the time windows). An example is illustrated in FIG. 8.

FIG. 8 illustrates an example configuration of different sleep cycles in the vicinity of a coverage gap. For example, in time window₁ the UE is allowed to skip the monitoring occasions and may enter sleep, and in time window₂ the UE is configured with a sleep cycle that has frequent monitoring occasions (more frequent than in the normal case where there is coverage and outside the time windows).

In some embodiments, the configuration of the DRX cycles, e.g., (e)DRX₁, and (e)DRX₂, is performed similar to the configuration of the DRX cycle as in legacy for RRC_IDLE or RRC_INACTIVE mode. Note that for the latter this text is not referring to the RAN paging cycle. Such signaling is performed typically via NAS layer, which is transparent to the gNB or eNB, but in a variant it can as well be performed via the AS layer.

Some embodiments may use the RAN paging cycle, which is configured by the radio access network (RAN). In other words, the DRX cycles within the time windows can be configured by the RAN, either via broadcast or dedicated signaling. If broadcasted, in one option, the UE adopts a DRX cycle that would be valid within the time window prior to or after the coverage gap(s) or both from a set of values based on an identifier such as UE-ID (e.g., the UE_ID parameter or the UE_ID_H parameter used in the currently specified PO algorithms. In another option, the UE adopts a default DRX cycle within the time window(s) which is broadcasted explicitly or the default paging cycle in the cell is used. In a variant to the options above, the network may broadcast a set of offset values from which the UE selects based on an identifier such as UE-ID (e.g., the UE_ID parameter or the UE_ID_H parameter used in the currently specified PO algorithms or based on the timing of the coverage gap at the UE's specific location.

In some embodiments, network PO selection is based on UE reported location. In moving beams/cells deployments, the timing of coverage gaps (in terms of start and end times) depends on each UE's specific location, i.e., the coverage gap timing is location dependent and thus to a large extent UE specific. Therefore, in some embodiments, the network selects special PO(s) for a UE based on the UE's specific location.

To support this, a UE may report its location (e.g., based on GNSS measurements) when it is in contact with the network, e.g., in conjunction with the UE's initial registration with the network (e.g., in conjunction with the Attach procedure in LTE), during Tracking Area Updates (periodic or triggered by entrance into a tracking area which is not included in the UE's configured list of tracking areas) or Registration Requests for mobility updating or periodic updating, or in conjunction with transition to RRC_CONNECTED state or at any time while the UE is in RRC_CONNECTED state. Even while in RRC_IDLE or RRC_INACTIVE state, the UE may as one option contact the network at any time to report its location, e.g., when the UE's location has changed a significant distance since the last reported UE location.

For such updates of the UE's location information triggered by change of the location, the network may configure a threshold distance to be measured from the last reported location and if the UE moves beyond it, this triggers the UE to contact the network to report its new location. For such reporting, a Tracking Area Update Request message or a Registration Request message may be used, or a new RRC message may be specified for this purpose. Another alternative for this kind of UE reporting may be to use a MAC layer message.

When the UE's location is known to the network, it can calculate roughly when the UE will lose and regain coverage and the network may then select a set of (special) PO(s) short before and/or after the coverage gap to replace any of the UE's PO(s) that may occur during the coverage gap. In the moving beams/cells case, the start and end of a coverage gap for a UE does not only depend on the UE's location but also on the channel quality the UE experiences, thus the network may select a series of (special) POs, wherein the series of POs spans a time period during which the UE can be expected to gradually lose coverage or gradually regain coverage. Such a series of POs may be spaced in time by intervals equal to the UE's regular paging (c)DRX cycle length or the network may alternatively choose another inter-PO interval length, e.g., shorter than the UE's regular (e)DRX cycle length. An additional option is that the network may choose varying inter-PO intervals, i.e., different interval lengths may be used between different PO pairs. The network may convey the PO configuration information to the UE at any time while the UE is in RRC_CONNECTED state, such as in the RRCConnectionRelease message in LTE or the RRCRelease message in NR. In addition, the network may convey the PO configuration information to the UE in conjunction with Tracking Area Update procedures or Registration procedures, e.g., in response to a reported UE location. As yet another option, the network may page the UE to convey the PO configuration information, e.g., in a modified Paging message.

In the embodiments described above, the coverage gap timing and the allocation of (special) PO(s) may be UE specific, but as an option, the network may choose to group UEs located relatively close to each other in this configuration and use the same PO allocation (based on the same rough expected coverage gap timing) for all UEs in the group. As one option, the network may use group signaling for the configuration, e.g., using the GC-PDCCH in NR, e.g., to schedule an RRC message or a MAC message that carries the PO configuration data to the UEs. As another option, the network may page the UEs, e.g., using group paging, to convey the PO configuration information, e.g., in a modified Paging message.

In some embodiments, the network determines to transmit a paging message to multiple UEs in one paging occasion based on the UEs' specific locations. For example, for UEs with an overlapping of the time window without coverage, the network may group paging to the UEs with overlapping time windows into one paging occasion, so that it is easier to find an early common paging occasion to transmit the paging messages to multiple UEs to improve the resource utilization efficiency.

Some embodiments use a pseudo-UE_ID to shift PO(s) to avoid coverage gaps. If the duration of a coverage gap is shorter than a UE's (e)DRX cycle, but one of UE's regular POs occurs during the coverage gap, the network may shift the cycle such that the coverage gap occurs between two POs. In the regular PO algorithm, the UE_ID parameter is used to distribute UEs to different POs, i.e., in practice set the “phase” of the cycle for a particular UE. In LTE, the UE_ID parameter in the PO algorithm for regular DRX is IMSI mod 1024 (or IMSI mod 4096 if the UE monitors paging on the NPDCCH) and in the PO algorithm for eDRX the UE_ID parameter is replaced by the UE_ID_H parameter, which is a 10 or 12 bit parameter derived from the S-TMSI. In NR, the UE_ID parameter used in the PO algorithm is 5G-S-TMSI mod 1024.

In some embodiments, the network may leverage this usage of the UE_ID (or UE_ID_H) parameter in the PO algorithm and, if one of the UE's POs occurs during a coverage gap, the network may assign a pseudo-UE_ID parameter (or pseudo-UE_ID_H parameter) that replaces the regular UE_ID (or UE_ID_H) parameter, i.e., the UE should use the pseudo-UE_ID (or pseudo-UE_ID_H) parameter in the PO algorithm when it determines the timing of its POs. The network chooses and assigns a pseudo-UE_ID (or pseudo-UE_ID_H) parameter that shifts the UE's (e)DRX cycle such that no PO occurs during the coverage gap.

Even if the coverage gap is longer than the UE's (e)DRX cycle, the network may assign a pseudo-UE_ID (or pseudo-UE_ID_H) parameter to the UE that shifts the (e)DRX cycle in a way that minimizes the number of POs that occur during the coverage gap (e.g., reducing this number from N to N−1).

As an additional possible usage of a pseudo-UE_ID (or pseudo-UE_ID_H parameter) in the previously described embodiments, the UE can assign one for itself and inform the network as an indication of the UE's choice of additional (special) PO(s) before or after a coverage gap.

Some embodiments include repeated signaling of PO configuration information for one time period at a time. For example, in some embodiments, the network can assign replacement PO(s) for a UE or a group of UEs—or all UEs in a cell—for a certain time period, e.g., covering one or a series of coverage gaps. When the time period for which the network has provided replacement PO configuration elapses (or before it elapses), the network may provide new (updated) replacement PO configurations.

One way the network may provide a new PO configuration is via paging, where the PO configuration information may be included in a modified paging message. When the PO configuration is compact, e.g., an index pointing out a preconfigured or specified configuration, then it may be confined in the DCI on the PDCCH (or NPDCCH), instead of using a message on the PDSCH.

Some embodiments include special considerations for earth fixed beams/cells deployments. In contrast to the case of moving beams/cells, earth fixed cells are switched when the satellite and/or gNB/eNB serving the cell area is switched, which means that the entire cell area is either covered by a cell or not covered by a cell. Within an area that is intermittently covered as an earth fixed cell, the presence and absence of coverage (and thus the occurrence of coverage gaps) is thus independent of the location.

As a consequence, in embodiments where the network configures additional (special) PO(s), it is not dependent on the UE's location (other than that the UE is located within the earth fixed cell area). Thus, reporting of the UE's location (for this purpose) may be omitted.

Furthermore, in embodiments where the UE selects additional (special) PO(s) or replacement PO(s) according to a predetermined rule, the UE does not have to report the PO(s) it selected to the network, because the network can foresee the UE's PO selection.

An additional consequence for earth fixed beams/cells is that there is less benefit to providing PO configurations adapted to a specific UE or group of UEs. The network may instead provide the same PO configuration related to a coverage gap to all UEs in an earth fixed cell area, e.g., using broadcast signaling, such as the system information. It may still be beneficial to ensure that not all the UEs in the cell use the same PO(s), so previously described schemes where a UE-ID parameter (e.g., the UE_ID or UE_ID_H parameter) is used to assign UEs to a subset of the configured additional POs may be useful.

Some embodiments account for PSM UE behavior amid discontinuity. A UE in power saving mode (PSM) configured with periodic tracking area update (TAU) wakes up to transmit TAU at the expiry of timer T3412. In the TAU attach or accept message, the network may configure the UE with values for timer T3412 and another timer T3422. Upon transitioning from connected mode to idle mode following a TAU, the UE starts the active timer (T3422) and remains in the idle mode for the duration of T3422 to provide mobile-terminated reachability. Upon its expiry, the UE will return to PSM mode.

Some embodiments define a new behavior related to active timer for PSM UEs where the onset of the active timer is delayed by a predetermined duration. The pre-determined duration or offset may be specified, or broadcast in the cell using SI, or indicated to the UE using RRC signaling or in the TAU attach or accept message.

As one example, an NTN UE wakes up from PSM to perform a TAU before an NTN discontinuity event. The network anticipates that the UE reachability duration if it runs the active timer upon returning to idle mode overlaps with the discontinuity event. The network configures the UE with an offset larger than the discontinuity duration in the TAU accept message. As a result, the UE does not immediately start the active timer after the discontinuity and remains reachable after the discontinuity event.

In another example, the network sets the delay to 0. As a result, the legacy behavior is realized where the UE runs the active timer upon transitioning from connected to idle mode.

In another embodiment, if a non-zero delay (as described in the previous embodiment) is configured by the network, the UE may return to PSM for the duration of the delay. At the end of the delay duration, the UE is not required to send a TAU. Instead, the UE will move to the idle mode and run the active timer to remain reachable. Upon expiry of the active timer, the UE will return to PSM.

As one example, without the above specified behavior, the UE may unnecessarily waste energy by attempting to stay in the idle mode for the duration of discontinuity.

Some of the embodiments described herein are dependent on determining when a UE is in coverage or not. For example, based on the UE coverage estimate using satellite assistance information, e.g., satellite ephemeris information, or any other means, e.g., broadcast information that indicates an area where there is no network coverage.

The UE may determine its UE specific timing advance pre-compensation or the UE-gNB round trip time (RTT) from its location (available from a GNSS receiver) and satellite ephemeris or by using a broadcasted time stamp and knowledge of the exact time (available from a GNSS receiver). The UE may then, using ephemeris knowledge, estimate future UE specific timing advance pre-compensation or future UE estimated UE-gNB RTT.

In some embodiments, the UE or gNB determines when it will be in coverage by comparing a threshold to the UE specific timing advance pre-compensation and/or comparing to the UE estimated UE-gNB RTT (including). The threshold may be provided to the UE by the gNB via broadcast or dedicated signaling. By using the ephemeris information, the UE and/or gNB may determine when in the future the UE will be in coverage and/or for how long the UE will be in coverage. This can be done for any satellite where the ephemeris is known to the UE and/or gNB.

The terms beam and cell have been used interchangeably, unless explicitly noted otherwise. Certain embodiments describe NTN in the context of IoT, but the methods proposed apply to any wireless network dominated by line-of-sight conditions.

Certain embodiments may relate to one or more of: NB-IoT, eMTC, LTE-M, Cat-M, NR, LTE, 5G, DRX, eDRX, cell search, cell selection, cell reselection, anchor carrier, non-anchor carrier, intra-frequency measurement, inter-frequency measurement, measurement occasion, and/or measurement opportunity.

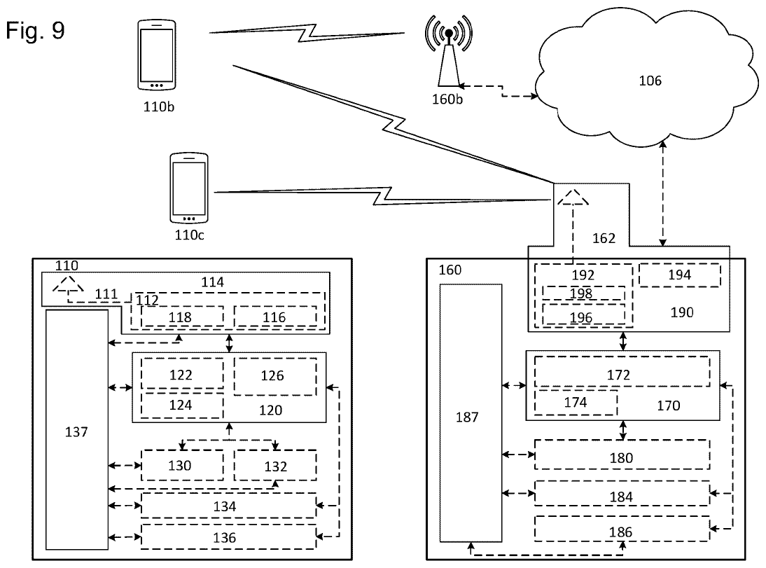

FIG. 9 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 160 includes processing circuitry 170, device readable medium 180, interface 190, auxiliary equipment 184, power source 186, power circuitry 187, and antenna 162. Although network node 160 illustrated in the example wireless network of FIG. 9 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 9 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

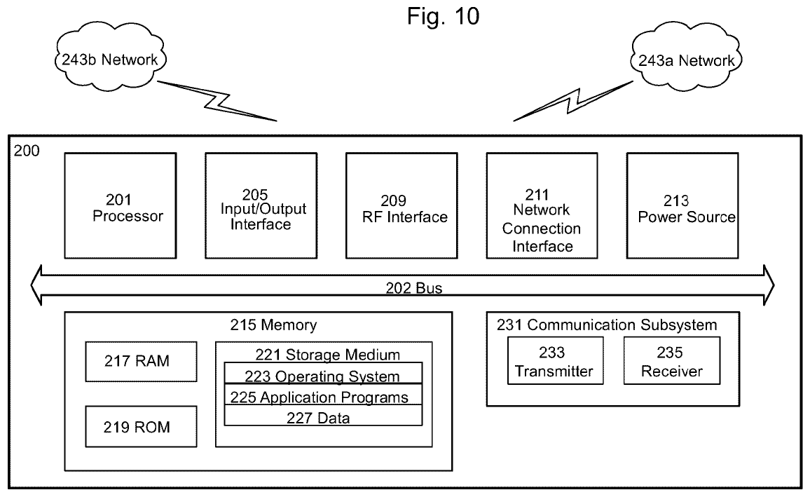

FIG. 10 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3rd Generation Partnership Project (3GPP), including a NB-IoT UE, a machine type communication (MTC) UE, and/or an enhanced MTC (eMTC) UE. UE 200, as illustrated in FIG. 10, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 10, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

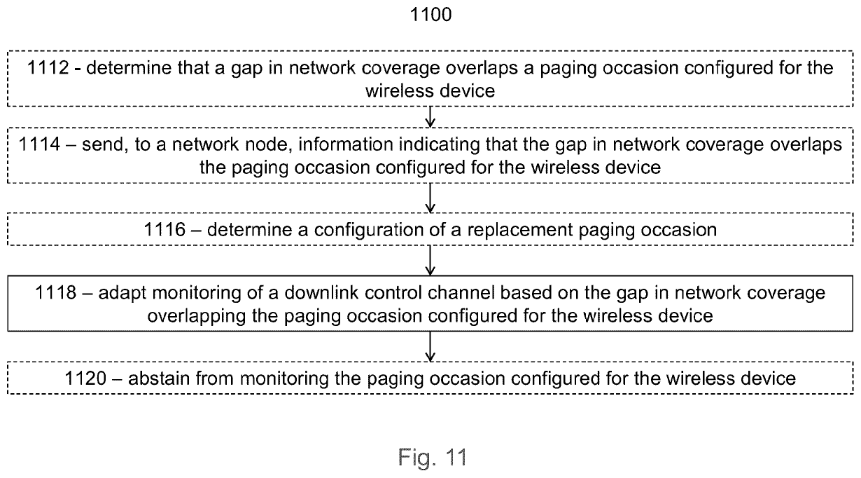

FIG. 11 is a flowchart illustrating an example method in wireless device, according to certain embodiments. In particular embodiments, one or more steps of FIG. 11 may be performed by wireless device 110 described with respect to FIG. 9.

The method may begin at step 1112, where the wireless device (e.g., wireless device 110) determines that s gap in network coverage overlaps a paging occasion configured for the wireless device (e.g., a scheduling paging occasion occurs during or near the gap in network coverage). The gap in network coverage may be caused, for example, when a satellite of the NTN is unavailable.

At step 1114, the wireless device may send, to a network node, information indicating that the gap in network coverage overlaps the paging occasion configured for the wireless device. This, for example, lets the network node know that the wireless device will not receive paging at a particular paging occasion and the network node can take appropriate action, such as refraining from paging, or modifying the paging configuration for one or more wireless devices.

At step 1116, the wireless device may determine a configuration of the replacement paging occasion. The configuration of the replacement paging occasion may indicate when the replacement paging occasion occurs. The configuration of the replacement paging occasion may be determined at least in part based on information received from a network node.

At step 1118, the wireless device adapts monitoring of a downlink control channel (e.g., PDCCH) based on the gap in network coverage overlapping the paging occasion configured for the wireless device. Adapting monitoring of the downlink control channel comprises monitoring the downlink control channel during a replacement paging occasion.

In particular embodiments, the method comprises monitoring the downlink control channel both during the paging occasion configured for the wireless device and during the replacement paging occasion.

In particular embodiments, the replacement paging occasion includes a paging occasion prior to the gap in network coverage and/or after the gap in network coverage. The paging occasion configured for the wireless device may be based on an active portion of a discontinuous reception cycle or a power saving mode cycle. The replacement paging occasion occurs outside of the active portion of the discontinuous reception cycle or the power saving mode cycle.

In particular embodiments, the wireless device adapts the monitoring of the downlink control channel according to any of the embodiments and examples described herein.

At step 1120, the wireless device may, based on the gap in the network coverage overlapping the paging occasion configured for the wireless device, abstain from monitoring the paging occasion configured for the wireless device.

Modifications, additions, or omissions may be made to method 1100 of FIG. 11. Additionally, one or more steps in the method of FIG. 11 may be performed in parallel or in any suitable order.

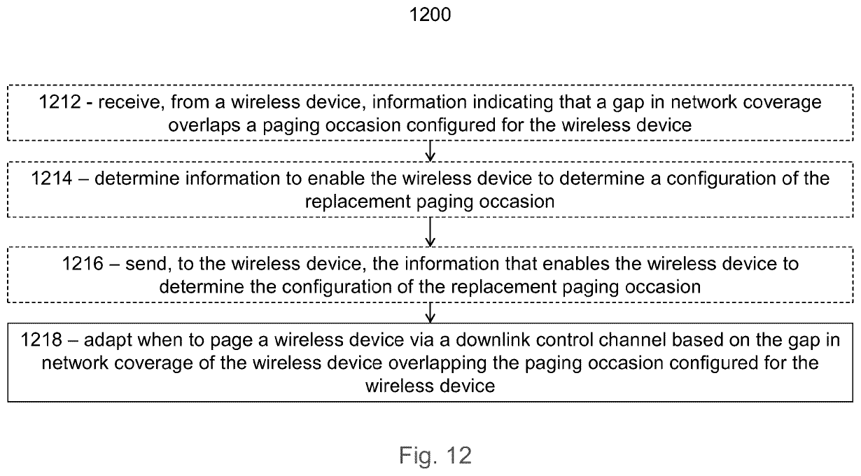

FIG. 12 is a flowchart illustrating an example method in a network node, according to certain embodiments. In particular embodiments, one or more steps of FIG. 12 may be performed by network node 160 described with respect to FIG. 9.

The method may begin at step 1212, where the network node (e.g., network node 160) may receive, from a wireless device, information indicating that a gap in network coverage overlaps a paging occasion configured for the wireless device. The network node may use the information to adapt when to page the wireless device.

At step 1214, the network node may determine information to enable the wireless device to determine a configuration of a replacement paging occasion. The configuration of the replacement paging occasion may indicate when the replacement paging occasion occurs.

At step 1216, the network node may send, to the wireless device, the information that enables the wireless device to determine the configuration of the replacement paging occasion.

At step 2118, the network node adapts when to page the wireless device via a downlink control channel based on the gap in network coverage of the wireless device overlapping the paging occasion configured for the wireless device. Adapting when to page the wireless device comprises paging the wireless device during a replacement paging occasion.

In particular embodiments, the method comprises paging the wireless device both during the paging occasion configured for the wireless device and during the replacement paging occasion.

In particular embodiments, based on the gap in the network coverage overlapping the paging occasion configured for the wireless device, the network node abstains from paging the wireless device during the paging occasion configured for the wireless device.

In particular embodiments, the replacement paging occasion includes a paging occasion prior to the gap in network coverage or after the gap in network coverage. The paging occasion configured for the wireless device may be based on an active portion of a discontinuous reception cycle or a power saving mode cycle. The replacement paging occasion occurs outside of the active portion of the discontinuous reception cycle or the power saving mode cycle.

Modifications, additions, or omissions may be made to method 1200 of FIG. 12. Additionally, one or more steps in the method of FIG. 12 may be performed in parallel or in any suitable order.

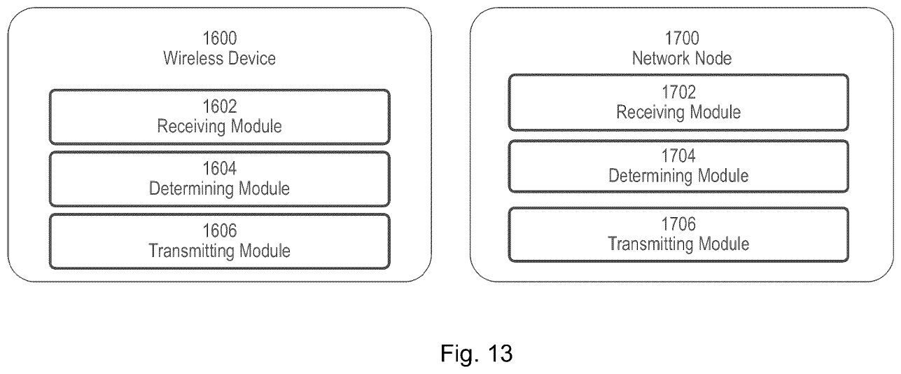

FIG. 13 illustrates a schematic block diagram of two apparatuses in a wireless network (for example, the wireless network illustrated in FIG. 9). The apparatuses may comprise a network node and a wireless device (e.g., wireless device 110 and network node 160 in FIG. 9). Apparatuses 1600 and 1700 are operable to carry out the example methods described with reference to FIGS. 11 and 12, respectively. Apparatuses 1600 and 1700 may be operable to carry out other processes or methods disclosed herein. It is also to be understood that the methods of FIGS. 11 and 12 are not necessarily carried out solely by apparatuses 1600 and 1700. At least some operations of the method can be performed by one or more other entities.

Virtual apparatus 1600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause receiving module 1602, determining module 1604, transmitting module 1606, and any other suitable units of apparatus 1600 to perform corresponding functions according one or more embodiments of the present disclosure.

As illustrated in FIG. 13, apparatus 1600 includes receiving module 1602 configured to receive information about a gap in network coverage and information scheduling paging occasions, according to any of the embodiments and examples described herein. Determining module 1604 is configured to determine that a gap in network coverage overlaps a paging occasion configured for the wireless device, according to any of the embodiments and examples described herein. Transmitting module 1606 is operable to send, to a network node, information indicating that a gap in network coverage overlaps a paging occasion configured for the wireless device, according to any of the embodiments and examples described herein.

In some implementations, the processing circuitry may be used to cause receiving module 1702, determining module 1704, transmitting module 1706, and any other suitable units of apparatus 1700 to perform corresponding functions according one or more embodiments of the present disclosure.

As illustrated in FIG. 13, apparatus 1700 includes receiving module 1702 configured to receive, from a wireless device, information indicating that a gap in network coverage overlaps a paging occasion configured for the wireless device, according to any of the embodiments and examples described herein. Determining module 1704 is configured to determine information to enable the wireless device to determine a configuration of a replacement paging occasion, according to any of the embodiments and examples described herein. Transmitting module 1706 is configured to send, to the wireless device, the information that enables the wireless device to determine the configuration of the replacement paging occasion and to page the wireless device, according to any of the embodiments and examples described herein.

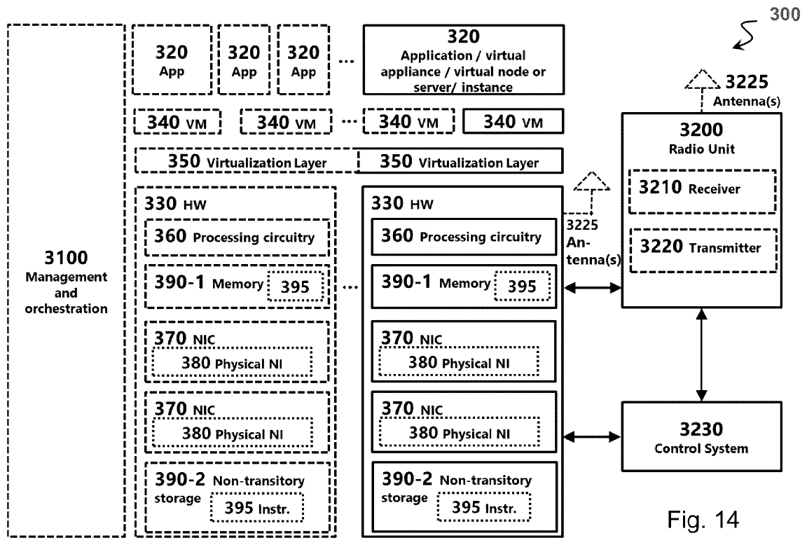

FIG. 14 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 14, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 14.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

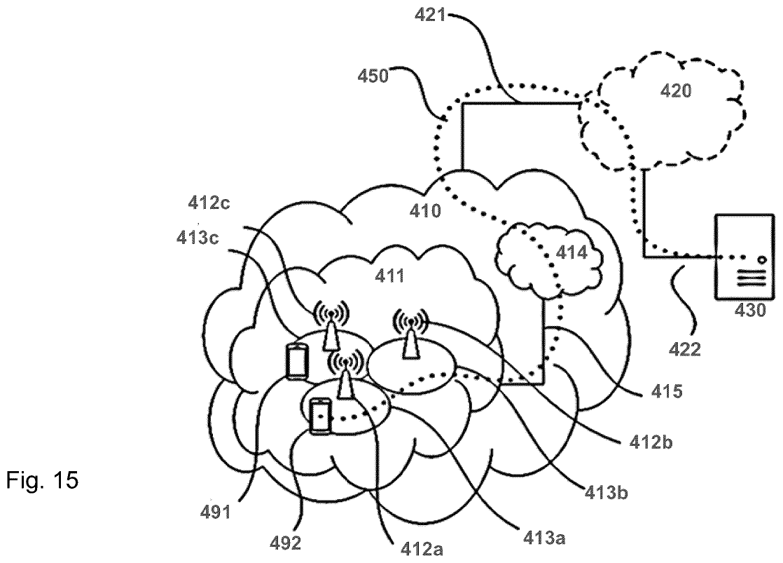

With reference to FIG. 15, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 15 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

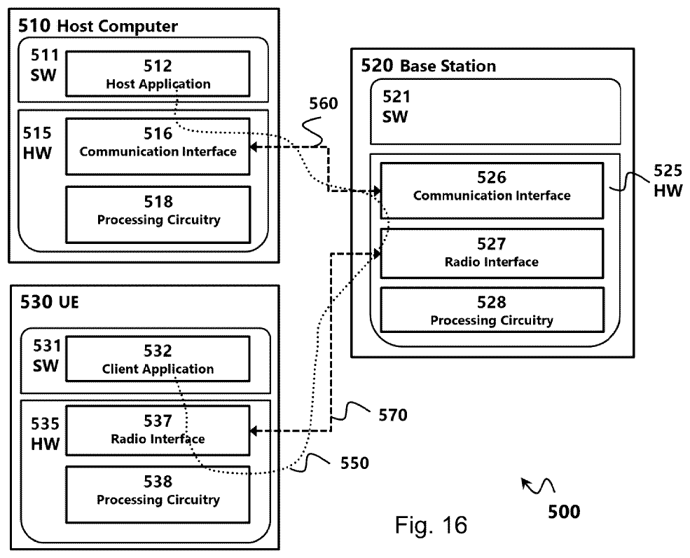

FIG. 16 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 16. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 16) served by base station 520. Communication interface 526 may be configured to facilitate connection 560 to host computer 510. Connection 560 may be direct, or it may pass through a core network (not shown in FIG. 16) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 16 may be similar or identical to host computer 430, one of base stations 412a, 412b, 412c and one of UEs 491, 492 of FIG. 15, respectively. This is to say, the inner workings of these entities may be as shown in FIG. 16 and independently, the surrounding network topology may be that of FIG. 15.

In FIG. 16, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a wireless device, the method comprising:
adapting monitoring of a downlink control channel based on a gap in network coverage overlapping a paging occasion configured for the wireless device, wherein adapting monitoring of the downlink control channel comprises monitoring the downlink control channel during a replacement paging occasion.

2. The method of claim 1, wherein the method comprises monitoring the downlink control channel both during the paging occasion configured for the wireless device and during the replacement paging occasion.

3. The method of claim 1, wherein, based on the gap in the network coverage overlapping the paging occasion configured for the wireless device, the method further comprises abstaining from monitoring the paging occasion configured for the wireless device.

4. The method of claim 1, wherein the replacement paging occasion includes a paging occasion prior to the gap in network coverage.

5. The method of claim 1, wherein the replacement paging occasion includes a paging occasion after the gap in network coverage.

6. The method of claim 1, wherein the paging occasion configured for the wireless device is based on an active portion of a discontinuous reception cycle or a power saving mode cycle, and wherein the replacement paging occasion occurs outside of the active portion of the discontinuous reception cycle or the power saving mode cycle.

7. The method of claim 1, further comprising:
determining that the gap in network coverage overlaps the paging occasion configured for the wireless device; and
sending, to a network node, information indicating that the gap in network coverage overlaps the paging occasion configured for the wireless device.

8.-10. (canceled)

11. A wireless device comprising processing circuitry operable to:
adapt monitoring of a downlink control channel based on a gap in network coverage overlapping a paging occasion configured for the wireless device, wherein adapting monitoring of the downlink control channel comprises monitoring the downlink control channel during a replacement paging occasion.

12. The wireless device of claim 11, wherein the processing circuitry is operable to monitor the downlink control channel both during the paging occasion configured for the wireless device and during the replacement paging occasion.

13. The wireless device of claim 11, wherein, based on the gap in the network coverage overlapping the paging occasion configured for the wireless device, the processing circuitry is operable to abstain from monitoring the paging occasion configured for the wireless device.

14. The wireless device of claim 11, wherein the replacement paging occasion includes a paging occasion prior to the gap in network coverage.

15. The wireless device of claim 11, wherein the replacement paging occasion includes a paging occasion after the gap in network coverage.

16. The wireless device of claim 11, wherein the paging occasion configured for the wireless device is based on an active portion of a discontinuous reception cycle or a power saving mode cycle, and wherein the replacement paging occasion occurs outside of the active portion of the discontinuous reception cycle or the power saving mode cycle.

17. The wireless device of claim 11, the processing circuitry further operable to:
determine that the gap in network coverage overlaps the paging occasion configured for the wireless device; and
send, to a network node, information indicating that the gap in network coverage overlaps the paging occasion configured for the wireless device.

18.-30. (canceled)

31. A network node comprising processing circuitry operable to:
adapt when to page a wireless device via a downlink control channel based on a gap in network coverage of the wireless device overlapping a paging occasion configured for the wireless device, wherein adapting when to page the wireless device comprises paging the wireless device during a replacement paging occasion.

32. The network node of claim 31, wherein the processing circuitry is operable to page the wireless device both during the paging occasion configured for the wireless device and during the replacement paging occasion.

33. The network node of claim 31, wherein, based on the gap in the network coverage overlapping the paging occasion configured for the wireless device, the processing circuitry is operable to abstain from paging the wireless device during the paging occasion configured for the wireless device.

34. The network node of claim 31, wherein the replacement paging occasion includes a paging occasion prior to the gap in network coverage.

35. The network node of claim 31, wherein the replacement paging occasion includes a paging occasion after the gap in network coverage.

36. The network node of claim 31, wherein the paging occasion configured for the wireless device is based on an active portion of a discontinuous reception cycle or a power saving mode cycle, and wherein the replacement paging occasion occurs outside of the active portion of the discontinuous reception cycle or the power saving mode cycle.

37. The network node of claim 31, the processing circuitry further operable to:
receive, from the wireless device, information indicating that the gap in network coverage overlaps the paging occasion configured for the wireless device; and
wherein the processing circuitry is operable to adapt when to page the wireless device based at least in part on receiving the information.

38. The network node of claim 21, the processing circuitry further operable to determine information to enable the wireless device to determine a configuration of the replacement paging occasion.

39. The network node of claim 38, wherein the configuration of the replacement paging occasion indicates when the replacement paging occasion occurs.

40. The network node of claim 38, the processing circuitry further operable to send, to the wireless device, the information that enables the wireless device to determine the configuration of the replacement paging occasion.
